(19) United States
(12) Patent Application Publication
(10) Pub. No.: US 2017/0249627 A1
(43) Pub. Date: Aug. 31, 2017

(54) FINANCIAL TRANSACTION SYSTEMS AND METHODS

(71) Applicant: MY LIFE IT (AUST) PTY LTD, Blackburn (AU)

(72) Inventor: Richard Stanley Smythe, Lower Templestowe (AU)

(21) Appl. No.: 15/595,261

(22) Filed: May 15, 2017

Related U.S. Application Data
(63) Continuation-in-part of application No. 15/332,777, filed on Oct. 24, 2016.
Application No. 15/332,777 is a continuation of application No. 14/110,433, filed on Jan. 16, 2014, now abandoned.

(30) Foreign Application Priority Data
Apr. 5, 2011 (AU) 2011901257

(51) Int. Cl. G06Q 20/32; G06Q 20/12; G06Q 20/38; G06Q 20/10; G06Q 20/42

(52) U.S. Cl. CPC G06Q 20/3255; G06Q 20/10; G06Q 20/425; G06Q 20/385; G06Q 20/12; G06Q 20/3223; G06Q 20/327

(57) ABSTRACT

A computer-implemented method for facilitating the transfer of funds from a sending account to a receiving account, the method including the steps of: receiving first data from a first device, the first data including: first transaction data representing a first portion of information required to transfer the funds; and second device identification data uniquely identifying a second device; transmitting request data to the second device identified by the second device identification data, at least a portion of the request data being derived from the first data; receiving from the second device second transaction data representing a second portion of the information required to transfer the funds; and generating combined transaction data from the first transaction data and second transaction data for subsequent transmission to a transaction processor.

### CROSS REFERENCE

This application is a continuation-in-part and claims priority to U.S. patent application Ser. No. 15/332,777 filed on Oct. 24, 2016, which is a continuation and claims priority to U.S. patent application Ser. No. 14/110,433 filed Jan. 16, 2014, which is a 371 application of PCT/AU12/000327 filed Mar. 30, 2012, and claims priority to Foreign Application No. 2011901257 filed on Apr. 5, 2011, the specification(s) of which/are incorporated herein in their entirety by reference.

### FIELD

The present invention relates to methods and systems for facilitating the transfer of funds, for example, the payment of funds by a purchaser to a merchant in return for the provision of goods and/or services.

### BACKGROUND

There are numerous mechanisms by which one person (for example, a purchaser of goods and/or services) can transfer funds to another person (for example, a merchant who provides goods and/or services). For example, if the purchaser knows the account details of a merchant, the purchaser may directly deposit funds into the merchant's account. If the merchant possesses the appropriate equipment, the purchaser may use Electronic Funds Transfer at Point Of Sale (EFTPOS) equipment to execute the transfer of funds between accounts. Direct deposit of funds requires attendance at a bank branch, or access to banking computer systems (eg via the Internet). EFTPOS transactions require specialist EFTPOS equipment.

Alternatively, the purchaser may use shadow accounts (such as those implemented by Paypal, Inc) to effect the transfer of funds. However, the use of such shadow accounts generally requires electronic access to the shadow account provider (eg via the Internet).

In another alternative, the purchaser may also choose to use a credit card. Credit cards are a flexible payment mechanism. Point of Sale (POS) equipment may be used to capture the credit card and transaction details necessary for funds transfer. Paper-based imprinting systems may also be used to capture this information. Alternatively, relevant card information may be entered into a form in a website for purchases made over the Internet.

Credit card fraud typically involves the misuse of credit card details, by a person other than the credit card holder. It is desirable to reduce the opportunity for credit card fraud.

Where specialist equipment (such as POS equipment) is used to capture credit card details, the possibility of fraud is relatively low, assuming that the equipment has not been the subject of unauthorised tampering. However, such equipment is not always available. For example, it is inconvenient for tradespeople attending a customer's premises to carry mobile POS equipment in order to receive payment from a customer.

Where electronic equipment for capturing credit card information and transaction details is not available, the credit card information is generally supplied to the merchant, together with an implicit authorisation that the merchant can use those details to execute a transaction. This situation is highly vulnerable to fraud perpetrated by the merchant, or by a person who either intercepts the communication between the customer and the merchant, or gains access to the merchant's records containing the credit card details.

More recently, Internet banking and e-commerce have become more widely used as a mechanism for transferring funds. Internet banking, as the name suggests, requires Internet access (availability of which cannot be guaranteed at all points of sale), and e-commerce has some of the drawbacks referred to above, including that such transactions are highly vulnerable to fraud.

It is desired to address or ameliorate one or more of the aforementioned shortcomings or disadvantages of the prior art, or at least provide a useful alternative.

### SUMMARY

The present invention provides a computer-implemented method for facilitating the transfer of funds from a sending account to a receiving account, the method including the steps of:
(1) receiving first data from a first device, the first data including: first transaction data representing a first portion of information required to transfer the funds and second device identification data uniquely identifying a second device;
(2) transmitting request data to the second device identified by the second device identification data, at least a portion of the request data being derived from the first data;
(3) receiving from the second device second transaction data representing a second portion of the information required to transfer the funds; and
(4) generating combined transaction data from the first transaction data and second transaction data for subsequent transmission to a transaction processor.

The present invention also provides a system that enables a consumer electronic device to transfer funds from an account of a consumer (“consumer account”) to the account of a merchant (“merchant account”), via a telecommunications network. In some embodiments of the system, the telecommunications network may couple a merchant electronic device to a communications and processing server that is also coupled to a database server. In other embodiments, the merchant electronic device may also be operatively coupled to the database server, such that the merchant electronic device may send merchant account information to the database server via an Internet network. The database server may store the merchant account information and provide it to the communications and processing server at an initiation of a transfer of funds. The telecommunications network may also serve to couple the consumer electronic device to the communications and processing server. Thus, the merchant and consumer electronic devices are capable of sending and receiving messages to and from the communications and processing server via the telecommunications network.

In additional embodiments, the communications and processing server may be configured to receive a first SMS message from the merchant electronic device via the telecommunications network. This SMS message may comprise first transaction data having a first portion of a consumer credit card number, where the consumer credit card number is divided into a first portion and a second portion. Consumer electronic device identification data, which uniquely identifies the consumer electronic device, may also comprise the first SMS message. The consumer may provide both sets of data comprising the first SMS message to the merchant. In this way, the consumer is able to nominate the consumer electronic device by supplying the consumer electronic device identification data to the merchant.

In supplementary embodiments, the communications and processing server may be further configured to process the first SMS message and generate a request SMS message for transmission to the consumer electronic device identified by the consumer electronic device identification data. Following, a response SMS message from the consumer electronic device may then be received. At this point, the communications and processing server may verify the source of the response SMS message using the consumer electronic device data and identification data embedded in the response SMS message. Additionally, the response SMS message may contain second transaction data comprising the second portion of the consumer credit card number.

The system of the present invention may further comprise a message combining server, which is operatively coupled to the communications and processing server. This server is configured to combine the first and second transaction data to generate a combined transaction data, which is sufficient for deducting funds from the consumer account. The combined transaction data may comprise the complete consumer credit card number.

Consistent with previous embodiments, the combined transaction data may then be transmitted to a transaction processor via the message combining server. The message combining server may also transmit the information comprising the merchant account to the transaction processor after receiving said information from the communications and processing server. The transaction processor then accomplishes the transfer of funds from the consumer account to the merchant account.

The presently claimed invention amounts to significantly more than the abstract idea of facilitating a transfer of funds, in part, because it provides an improvement in the technology of electronic financial transactions. Namely, a system is presented that allows funds to be transferred from a consumer account to a merchant account solely using SMS messaging. Connection of a consumer electronic device to an Internet network is not required by the present invention. Additionally, a consumer's personal information is protected since the financial transaction is executed without exposing the consumer's complete credit card number to a merchant and since registration with a third-party is not required.

More specifically, as was the case for Bascom Global Internet v. AT&T Mobility LLC, the present system yields an improvement in the technology of electronic financial transactions by arranging known elements in an unconventional and non-generic combination. Arrangement of elements is as follows:
a merchant electronic device coupled to a remote server via a telecommunications network and to a remote database server via an Internet network;
a consumer electronic device coupled to the remote server via the telecommunications network; and
an electronic device identification scheme employed by the remote server, utilizing the consumer electronic identification device data and identification data embedded in the consumer's SMS response to verify the identity of the consumer.

Existing technologies require pre-registration/registration with a third-party in order to validate the identity of a consumer wishing to transfer funds from his account to a merchant account, thus unnecessarily exposing consumer personal information to the third-party. Further, this pre-registration/registration is consistently done over an Internet connection, which exposes consumer personal information to anyone skilled in the art of cyber theft. Existing technologies not requiring pre-registration/registration typically validate the identity of a consumer by requiring the consumer to submit personal information via the Internet, where oftentimes this information is the same set of information required for registration. It can thus be seen that prior existing technologies suffer from a technical limitation that constricts said technologies to use of the Internet and/or pre-registration/registration of a consumer. For instance, Tumminaro (US 2007/0233615 A1) discloses a member-supported mobile payment system where consumers conduct financial transactions with merchants via a mobile device. Enabling financial transactions is the registration of personal financial information, by both consumers and merchants, with the system. After registering, the consumer may initiate and complete a transaction via SMS messaging. Itoi (US 2010/0017334 A1) discloses a method and a system for authenticating a user (i.e., a consumer) by receiving a first portion of the consumer's credit card number via a first electronic device. The second portion is sent to an Internet shop (and subsequently to the system) via a second electronic device, where each portion is transmitted via an Internet network. Both Tumminaro and Itoi require that the consumer have access to at least one electronic device connected to an Internet network in order to complete a financial transaction. Any imaginable combination of the Tumminaro and Itoi prior art requires a consumer electronic device connected to an Internet network. Further, requisite motivation to combine Tumminaro and Itoi is lacking since removing the requirement (i.e., the consumer electronic device's connection to an Internet network) necessitates a complete reconstruction and redesign of Tumminaro's (and Itoi's) construction, as well as a change in the foundational principles under which Tumminaro's (and Itoi's) construction was designed to function.

The aforementioned technical limitations exhibited by the prior art are overcome by the technical solution of the present invention, as the system of the present invention provides a way for a consumer to transfer funds from a consumer account to a merchant account via SMS messaging alone. The technical solution comprises validating the identity of a consumer via a scheme employed at a remote server, where the remote server also facilitates communication between the consumer and merchant electronic devices. The consumer nominates an electronic device from which a second portion of consumer personal information is sent, via SMS, to the remote server. The first portion is sent, via SMS, to the remote server via a merchant electronic device (the first and second portion of consumer personal information is sufficient to complete a transfer of funds, said information includes, but is not limited to, a consumer credit card number, expiration date, and security code). As the first portion of consumer personal information contains electronic device nomination information (e.g. an electronic device phone number), the system of the present invention is able to verify that the second portion of the information originates from the electronic device nominated by the consumer (as detailed in the device nomination information contained in the first portion of consumer personal information).

### DRAWINGS

Preferred embodiments of the present invention are hereinafter described, by way of example only, with reference to the accompanying drawings, wherein:

FIGS. 1A-1B are a flow chart illustrating a method for facilitating the transfer of funds consistent with an embodiment of the present invention.

FIG. 2 is an illustration of a system for facilitating the transfer of funds consistent with an embodiment of the invention.

FIG. 3 is an illustration of an additional embodiment of the system for facilitating the transfer of funds consistent with the present invention.

### DESCRIPTION

Embodiments of the invention are suitable for facilitating the transfer of funds from a sending account (for example, an account controlled by a purchaser of goods and/or services) to a receiving account (for example, an account controlled by a merchant of the goods and/or services). Although an embodiment will be described in the context of mobile telephones using Short Messaging Service (SMS) messages to transfer data, embodiments of the invention may be implemented with a variety of hardware and communication protocols.

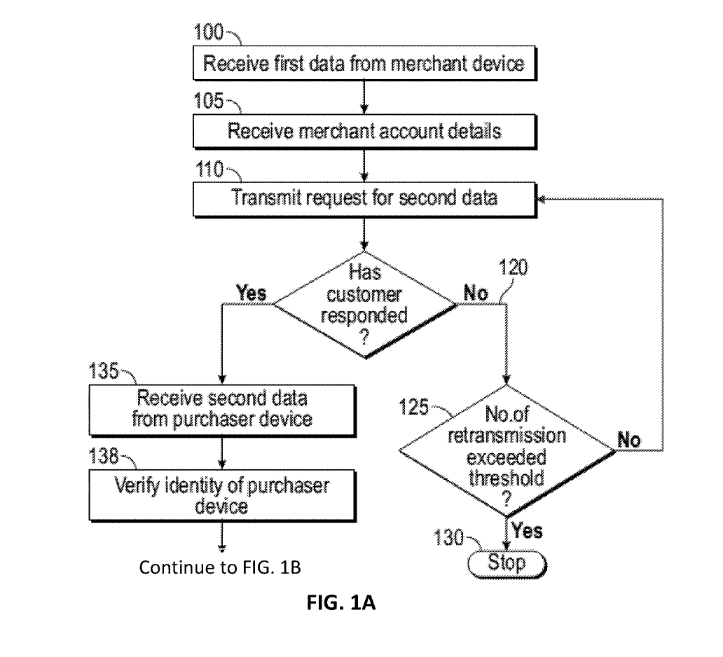

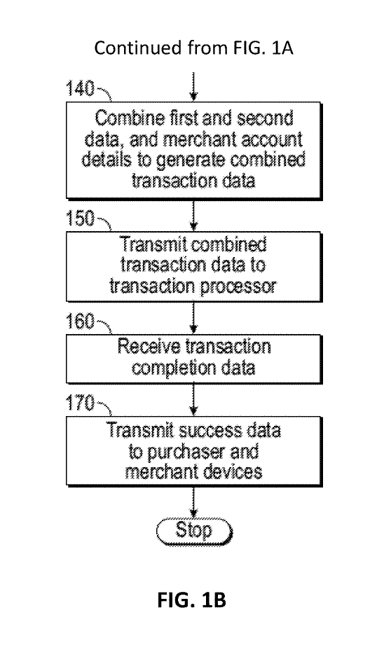

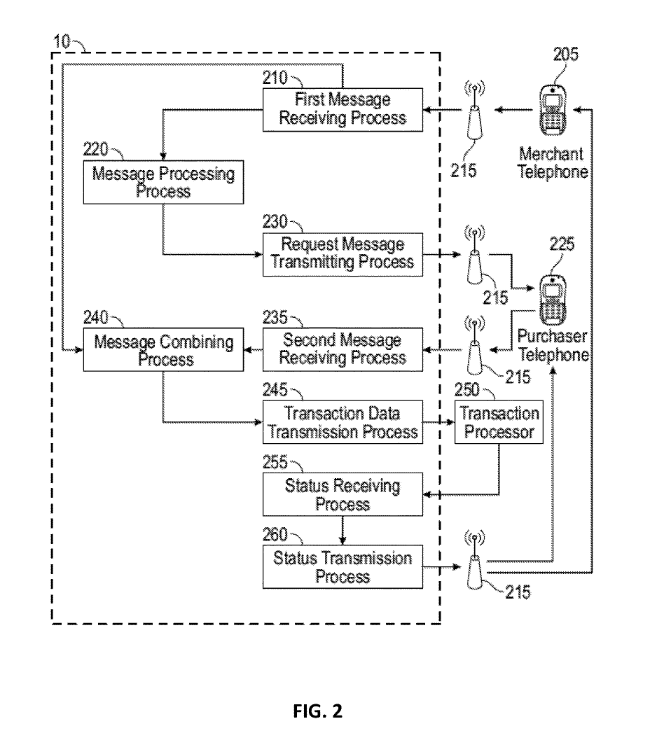

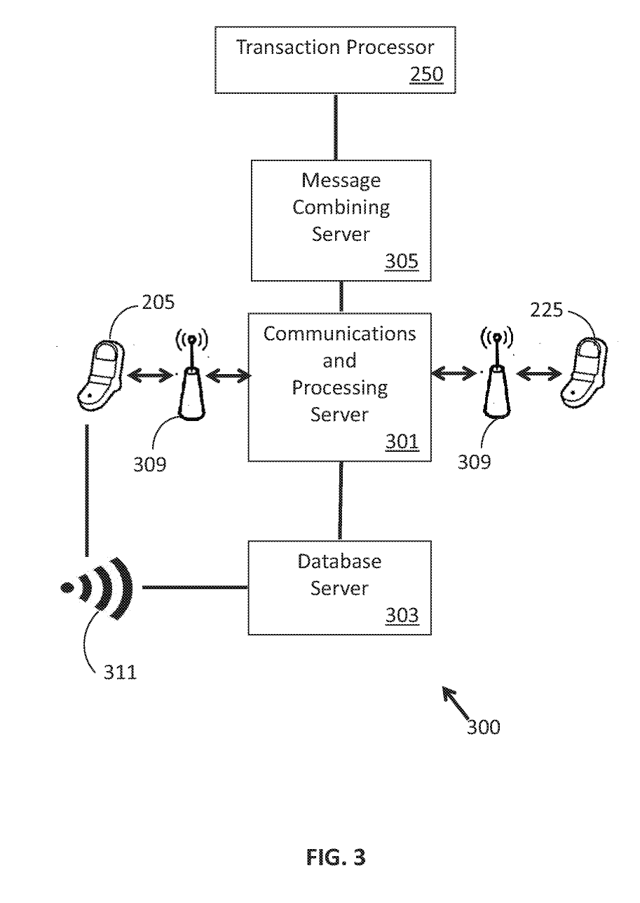

In one embodiment, a computer-implemented method for facilitating the transfer of funds is executed by a server 10, referred to hereinafter as an aggregation server. As illustrated in FIG. 1A, at step 100, the aggregation server 10 receives first data from a merchant device such as a merchant mobile telephone 205 (illustrated in FIG. 2). The first data sent from the merchant device 205 to the aggregation server 10 includes first transaction data representing a first portion of information required to transfer the funds and second device identification data uniquely identifying a second device. The first data may be in the form of an SMS message, this embodiment being suitable in an exemplary context of a householder paying a service provider, such as a plumber using, a mobile telephone for services rendered. Alternatively, the first data may be generated by software executing on the merchant device, based on data input by the merchant. In this alternative, the merchant device, which could be a portable computing device such as a smartphone or tablet, would execute software, which would prompt the merchant for information, which would enable the software to generate first data. In a further alternative, the first data may be in the form of data entered into a web-based form by the merchant on a merchant device, the web-based form being generated by the merchant device on instructions from a World Wide Web server, such as the Apache Web Server. For ease of explanation, embodiments of the invention shall be described in the context of the first data being in the form of an SMS message.

The SMS message may contain first transaction data. This first transaction data is, by itself, insufficient to enable the transaction to be executed. This first SMS message is sent from the plumber's mobile telephone and includes partial sending account data representing partial sending account details. The partial sending account data may be a partial credit card number of the householder's credit card. As only part of the householder's credit card number is transmitted in the SMS message from the plumber to the aggregation server 10, if this message is intercepted, the householder's credit card account will remain unidentifiable (a full credit card number being required to identify a credit card account). It is envisaged that the householder will inform the plumber of their partial credit card number, but it is not necessary for the householder to reveal all of the credit card number to the plumber to enter into this first SMS message. This reduces the probability of fraud being committed by the plumber, as the plumber does not have the whole credit card number. When the first data is not an SMS message, the merchant may enter the partial credit card number using a dedicated software interface or a web-based form.

The SMS message from the plumber also includes receiving account identification information identifying the receiving account. The receiving account in this case is the plumber's account into which the funds are to be received. The receiving account identification information may be the mobile telephone number of the plumber, automatically transmitted as part of the SMS message. Where the first data is not an SMS message, the receiving account information may be stored and sent by software executing on the plumber's device, or may be automatically sent (by means of a persistent cookie or otherwise) as part of a response to a web-based form.

As described above, the SMS message also includes second device identification data uniquely identifying a second device. This may be the purchaser's mobile telephone number, which uniquely identifies the purchaser's mobile telephone (consisting of the handset hardware and Subscriber Identification Module). Although the second device is preferably a mobile telephone, it could be any device in the possession of, or associated with, the purchaser, that can be contacted by the aggregation server 10, including a Public Switched Telephone Network (PSTN) line (or landline).

In one embodiment, the merchant has an account registered with the aggregation server 10, such that the aggregation server 10 has an account database (not shown) storing details of the merchant account. The mobile telephone number of the merchant (or any other identifier, such as a cookie, sent with the first data) can be used to retrieve, from this account database, account data representing information about the receiving account (step 105).

The merchant account may be associated with more than one mobile telephone number or other identifier, such that multiple merchant devices can use the same merchant account. This may be useful where there are multiple sales staff in a single organisation. Each staff member can use a device having a unique identifier. An administrator can modify access permissions to the merchant account (through aggregation server 10) so as to authorise or de-authorise devices from using the merchant account, in embodiments of the present invention.

In an alternative embodiment, the merchant is not registered with the aggregation server 10. In this embodiment, the first transaction data (included in the SMS or other message from the plumber) may contain information identifying a merchant account (such as account number, branch number, credit card number, shadow account identification etc). Preregistration by the merchant with the aggregation server 10 enables the aggregation server 10 to store details of a merchant account in the account database, thereby streamlining the process from the perspective of the merchant, as the merchant does not need to manually include its account details in the initiating SMS or other message.

In a further alternative embodiment, the merchant is registered with the aggregation server 10, but the receiving account identification information identifying the receiving account is a code included in the initiating SMS or other message.

An example of an initiating SMS message sent from the merchant device (the plumber's mobile telephone) is:
A17 455701123456 42595 0410557425 Receipt number 345659

The first three digits (“A17”) are a merchant identification code, identifying the merchant. As described above, this may not be necessary where the telephone number of the merchant's mobile telephone is used as an identification code (that is, receiving account identification information). Where devices other than mobile telephones are used, or where messaging systems other than SMS (such as instant messaging systems) are used, it is convenient to have an explicit merchant identification code within the message.

The next string of digits (following the space) represent the first 12 digits of the purchaser's 16-digit credit card number (that is, partial sending account data representing partial sending account details). These partial sending account details are insufficient to uniquely identify the sending account (that is, the purchaser's credit card).

The following string of digits (again, following space) is the quantum data representing an amount of the funds to be transferred (that is, the amount of the transaction), in cents. The amount of the transaction in this case is $425.95.

The subsequent string of digits (“0410557425”) is the second device identification data uniquely identifying a second device (in this case, the mobile telephone number of the purchaser).

The remaining text (“Receipt number 345659”) is description data representing a description associated with the transfer of funds. The merchant may use descriptor codes instead of a text description for standard goods or services. The aggregation server 10 can use these descriptor codes to look up a full description of the goods and/or services.

The aggregation server 10 executes computer-readable instructions to execute a first message receiving process 210 which listens for an initiating SMS message, received through a message receiving component such as an SMS Centre (SMSC) 215 (illustrated in FIG. 2). The received SMS message is sent to a message processing process 220 in the aggregation server 10. The message processing process 220 processes the received first data (the initiating SMS message) to derive a portion of the request data to be sent to the second device identified by the second device identification data (for example, the householder's mobile telephone). Where the merchant has not used SMS but some other mechanism to communicate with the aggregation server 10, such as a dedicated software application executing on a mobile computing device, or a web-based form, the message processing process 220 receives the message from an appropriate software interface of the aggregation server 10 (e.g. a World Wide Web server, in the case of the use of a web form).

Referring to the example initiating message given above, the message processing process 220 looks up a merchant account database to retrieve information about the receiving (merchant) account. Amongst other things, it retrieves the name of the merchant, and the merchant's account number (including branch details where necessary). It then constructs a request SMS containing request data. The request SMS may take the form:
<Merchant name> wants <amount> for <description>. Please reply with <transaction ID> lastfour_digits_of credit_card expiry_date CVV name_on_card to confirm payment eg <transaction ID>0123 0712 230 Peter Pan

As can be seen from this example, the <merchant name>, <amount> and <description> fields are derived from the initiating message from the merchant. The <transaction ID> is a unique alphanumeric transaction code generated by the aggregation server 10. An example request SMS message is.
Plumber Paul wants S425.95 for Receipt number 345659. Please reply with X417 last_four_digits_of credit_card expiry_date CVV name_on_card to confirm payment eg X417 0123 0712 230 Peter Pan

This message is sent to the purchaser's telephone 225 by a request message transmitting component such as a request message transmitting process 230 in aggregation server 10 through an SMSC 215.

Where the purchaser's device is a landline (or PSTN) telephone, this message may be sent to the purchaser by a call being made to the landline telephone and the message being read out to the purchaser through an interactive voice response or other interactive audio system.

A second message receiving component such as second message receiving process 235 awaits receipt from the purchaser's telephone 225 of a second message containing second transaction data representing a second portion of the information required to transfer the funds. If this second message is not received before the expiration of a predetermined time out (step 120), a check is made to determine whether the number of retransmissions of the first message has exceeded a predetermined threshold (step 125). If the predetermined threshold has not been exceeded, the first message is retransmitted (step 110). There are circumstances in which SMS messages are not successfully transmitted, and resending the request message until a response is received, a predetermined number of times, reduces the possibility that a transaction will be aborted due to a telecommunications error. If the predetermined threshold has exceeded, the transaction is aborted (step 130).

The purchaser may send the second message by SMS, where the second device (the purchaser's device) is a mobile telephone. However, if the purchaser's device is a landline, the purchaser may use another mechanism, such as an interactive voice response system, to provide information to the second message receiving process 235.

If the second message receiving process 235 receives a second message containing second transaction data representing a second portion of the information required to transfer the funds (step 135), it first verifies the identity of the device from which the second message containing the second transaction data is received (step 138) using the second electronic device identification data and device identification information embedded in the second message.

The second message receiving process 235 then passes the second message to a message combining component such as message combining process 240 which combines the first transaction data received from the merchant telephone 205 with second transaction data received from the purchaser's telephone 225 (step 140).

In the context of the example described above, the second message (response SMS) received from the purchaser or customer may be:
X417 7890 0411 123 Mr Tom Gold

The first string (“X417”) is the transaction identifier. The second string (“7890”) is the second part, or remainder, of the credit card details (being the last four digits). The third string (“123”) is the Card Security Code (otherwise known as the card verification value, card verification data, card verification value code, card verification code or card code verification), being a 3 digit number appearing on the back of the credit card. The last string (“Mr Tom Gold”) is the name on the card. In transmitting this SMS, the customer confirms the details of the transaction and authorises the transaction to take place. The information contained in this second message from the purchaser telephone 225 does not contain enough information, in itself, to execute the transaction. This message also does not have the complete details of the purchaser's credit card. Accordingly, should this message be intercepted (or unauthorised access be gained to a stored copy of this message), further information would be required before credit card fraud could be committed.

In an alternative embodiment, the purchaser may register with, and maintain an account on, aggregation server 10. Registered purchasers may generate a second message by sending to the aggregation server 10 a predetermined authorisation code, or an SMS or other message from their mobile telephone (which may operate as an authorisation code), and details of the transaction such as the transaction identifier. The aggregation server may use the authorisation code or mobile telephone number to query a user database and retrieve information about the user, including partial user credit card details.

As an alternative to sending an SMS or using an interactive voice response system with a landline telephone, the purchaser may use a dedicated software application, or a web-based application or form, to provide the necessary information to the second message receiving process 235.

As described above, the message combining process 240 combines the first transaction data received from the merchant telephone 205, and the second transaction data received from the purchaser telephone 225 to generate combined transaction data. Where the first transaction data includes receiving account identification information identifying the receiving account (instead of simply receiving account information), receiving account data, retrieved from the account database, representing information about the receiving account is also combined with the first transaction data and second transaction data. For example, if the initiating SMS from the merchant telephone 205 contained a merchant code (for example “A17”), this code would be used to retrieve from the account database the full details of the merchant, including the merchant's bank account details. The message combining process 240 would combine the merchant's bank account details (the receiving account data) with the first transaction data and the second transaction data to generate combined transaction data.
An example of information included in the combined transaction data is:
Transaction amount: $429.95
Payer credit card number: 4557011234567890
Payer name on card: Mr Tom Gold
Card expiry: 0411
Card CSC: 123
Payee account: 047-208 255348
Payee name: Plumber Paul
Description: Receipt number 345659

This combined transaction data is sent to a transaction processor 250 by means of a transaction data transmission process 245 running on aggregation server 10 (step 150). The transaction processor 250 may be a processor controlled by a financial institution such as a bank. The transaction processor is responsible for executing the transfer of funds. The combined transaction data is sent to the transaction processor 250 by means of a secure channel.

A status receiving process 255 running on aggregation server 10 receives from the transaction processor 250 transaction completion data indicating whether the funds were successfully transferred from the sending account to the receiving account (step 160). The transaction completion data may be in the form of a flag or other binary indicator indicating success/failure. This transaction completion data may be processed to generate success data for subsequent transmission to the purchaser telephone 225 and merchant telephone 205 through status transmission process 260, and SMSC 215 (step 170).

Where the transaction has been successful, the SMS message sent to the merchant telephone 205 may be in the form:
Success—you have received a payment of $425.95 from Mr Tom Gold for transaction X417

A similar SMS message may be sent to the purchaser telephone 225:
Success—you have paid Plumber Paul $425.95 for transaction X417

If the transaction failed, an SMS message may be sent to the merchant telephone 205 in the form:
FAIL—payment FAILED from Mr Tom Gold for transaction X417

And to the purchaser telephone 225:
FAIL—payment FAILED for Plumber Paul for transaction X417.

Many modifications will be apparent to those skilled in the art without departing from the scope of the present invention embodiments of which have herein been described with reference to the accompanying drawings. For example, although the embodiment above has been described in the context of the merchant and purchaser using mobile telephones connected with a mobile telephone network, and messages being sent using the Short Messaging Service, the invention could equally easily be used by any devices capable of sending and receiving messages (including instant messages) to and from an aggregation server 10. Although the aggregation server 10 is illustrated as a single server containing multiple executing processes, the number of processes required, and the number of computing systems that make up aggregation server 10, is a matter of design choice. For example, aggregation server 10 may be comprised of multiple computing units connected by a high-speed computer network. One or more processes may be executing on the aggregation server 10 to communicate with one or more SMSCs (in the case of communication by SMS) or other messaging facilities.

In addition, although the transaction described above involves the use of credit card details of a credit card of a purchaser, the invention is equally applicable to any financial transaction. For example, the partial sending account data may represent part of a bank account number, and not part of a credit card number.

The present invention also provides a system (300) that enables a consumer electronic device (225) to transfer funds from an account of a consumer (“consumer account”) to the account of a merchant (“merchant account”), via a mobile telecommunications network (309). In some embodiments of the system, the mobile telecommunications network (309) may couple a merchant electronic device (205) to a communications and processing server (301). In other embodiments, the communications and processing server (301) may also be coupled to a database server (303). Further, the merchant electronic device (205) may be operatively coupled to the database server (303) such that the merchant electronic device (205) may send merchant account information to the database server (303) via an Internet network (311). The database server (303) may store the merchant account information and provide it to the communications and processing server (301) at an initiation of a transfer of funds. The mobile telecommunications network (309) may also serve to couple the consumer electronic device (225) to the communications and processing server (301). Thus, the merchant and consumer electronic devices (225,205) are capable of sending and receiving messages to and from the communications and processing server (301) via the mobile telecommunications network (309).

In additional embodiments, the communications and processing server (301) may be configured to receive a first SMS message from the merchant electronic device (205) via the mobile telecommunications network (309). This SMS message may comprise first transaction data having a first portion of a consumer credit card number, where the consumer credit card number is divided into a first portion and a second portion. Consumer electronic device identification data, which uniquely identifies the consumer electronic device (225), may also comprise the first SMS message. In other embodiments, the first SMS message may further comprise a transaction descriptor or an amount to be transferred from the consumer account to the merchant account. In some embodiments, the consumer electronic device identification data may be a consumer mobile number associated with the consumer electronic device (225). The consumer may provide the first portion of the consumer credit card number and the consumer mobile number to the merchant. In this way, the consumer is able to nominate the consumer electronic device (225) by supplying the consumer mobile number to the merchant.

In supplementary embodiments, the communications and processing server (301) may be further configured to process the first SMS message and generate a request SMS message for transmission to the consumer electronic device (225) identified by the consumer mobile number. In some embodiments, the request SMS message may comprise the transaction descriptor or the amount to be transferred from the consumer account to the merchant account. Following, a response SMS message from the consumer electronic device (225) may be received. The response SMS message may contain second transaction data comprising the second portion of the consumer credit card number. In other embodiments, the response SMS message may further comprise the expiry date of a credit card bearing the consumer credit card number or a security code associated with the credit card bearing the consumer credit card number. At this point, the communications and processing server (301) may verify the source of the response SMS message using the consumer mobile number previously provided and identification data embedded in the response SMS message. Obtaining this embedded identification data may comprise extracting the mobile phone number from the SMS gateway response through which the response SMS message was sent and verification may comprise cross-checking the extracted number with the consumer mobile number provided.

The system (300) of the present invention may further comprise a message combining server (305), which may be operatively coupled to the communications and processing server (301). In some embodiments, the message combining server (305) may be configured to acquire (from the communications and processing server) and combine the first transaction data, the second transaction data, and information comprising the merchant account to generate a combined transaction data, which is sufficient for deducting funds from the consumer account.

Consistent with previous embodiments, the combined transaction data may then be transmitted to a transaction processor (250), via the message combining server (305), to complete the transfer of funds from the consumer account to the merchant account.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A system enabling a consumer electronic device to transfer funds from an account of a consumer, herein referred to as a consumer account, to the account of a merchant, herein referred to as a merchant account, via a mobile telecommunications network, the system comprising:
a merchant electronic device operatively coupled to a communications and processing server via the mobile telecommunications network, wherein the merchant electronic device is also operatively coupled to an Internet network;
a database server operatively coupled to the communications and processing server, wherein the merchant electronic device is operatively coupled to the database server via the Internet network, wherein the merchant supplies information comprising the merchant account to the database server via the Internet network, wherein the database server stores said information and provides the information to the communications and processing server at an initiation of a transfer of funds;
the consumer electronic device operatively coupled to the communications and processing server via the mobile telecommunications network, wherein the merchant and consumer electronic devices are capable of sending and receiving messages to and from the communications and processing server via the mobile telecommunications network;
the communications and processing server performing steps comprising:
receiving a first SMS message from the merchant electronic device via the mobile telecommunications network, the first SMS message comprising:
first transaction data comprising a first portion of a consumer credit card number, wherein the consumer credit card number comprises a first portion and a second portion; and
a consumer mobile number associated with the consumer electronic device for uniquely identifying the consumer electronic device,
wherein the consumer nominates the consumer electronic device by supplying the consumer mobile number to the merchant possessing the merchant electronic device;
processing the first SMS message to generate a request SMS message, which is transmitted to the consumer electronic device identified by the consumer mobile number; and
receiving a response SMS message from the consumer electronic device, wherein the communications and processing server verifies the source of the response SMS message using the consumer mobile number previously provided and identification data embedded in the response SMS message, wherein the response SMS message contains second transaction data comprising the second portion of the consumer credit card number; and
a message combining server, operatively coupled to the communications and processing server, for combining the first transaction data, the second transaction data and information comprising the merchant account to generate a combined transaction data sufficient for deducting funds from the consumer account,
wherein the combined transaction data is then transmitted to a transaction processor, wherein the transfer of funds from the consumer account to the merchant account is completed by the transaction processor.

2. A system as claimed in claim 1, wherein first transaction data comprising the first SMS message further comprises a transaction descriptor or an amount to be transferred from the consumer account to the merchant account.

3. A system as claimed in claim 2 wherein the request SMS message directed to the consumer electronic device comprises the transaction descriptor or the amount to be transferred from the consumer account to the merchant account.

4. A system as claimed in claim 1 wherein the second transaction data contained in the response SMS message further comprises an expiry date of a credit card bearing the consumer credit card number or a security code associated with the credit card bearing the consumer credit card number.

5. A computer-implemented method for facilitating the transfer of funds from a sending account to a receiving account using secure electronic communications, the method including the steps of:
receiving first data from a first electronic device via a telecommunications network, the first data including:
partial sending account data representing partial sending account details, wherein the partial sending account details are insufficient to uniquely identify the sending account; and
second electronic device identification data uniquely identifying a second electronic device;
wherein the first and second electronic devices are capable of sending and receiving messages via the telecommunications network;
transmitting request data to the second electronic device identified by the second electronic device identification data, via the telecommunications network, at least a portion of the request data being derived from the first data;
receiving second transaction data representing the remainder of the sending account details required to transfer the funds via the telecommunications network;
verifying that a source device from which the second transaction data is received is the second electronic device identified by the second electronic device identification data; and
generating combined transaction data from the first transaction data and second transaction data for subsequent transmission to a transaction processor.

6. A computer-implemented method as claimed in claim 5, further including the step of using the receiving account identification information to retrieve, from an account database, receiving account data representing information about the receiving account, and wherein the step of generating combined transaction data includes the step of generating combined transaction data from the first transaction data, second transaction data, and receiving account data.

7. A method as claimed in claim 6, further including the steps of:
transmitting the combined transaction data to the transaction processor; and
receiving from the transaction processor transaction completion data indicating whether the funds were successfully transferred from the sending account to the receiving account.

8. A computer-implemented method as claimed in claim 7 further including the step of transmitting success data derived from the transaction completion data to one or more of:
the first electronic device; and
the second electronic device.

9. A computer-implemented method as claimed in claim 5 wherein one or more of the steps of
receiving first data from the first electronic device;
transmitting request data to the second electronic device; and
receiving from the second electronic device second data, involves the transmission of data using a mobile telecommunications network.

10. A computer-implemented method as claimed in claim 9 where one or more of the:
first data;
request data; and
second data is in the form of one of:
an instant message; and
a short message sent using a short message service.

11. A computer implemented method as claimed in claim 9, wherein the second electronic device is a mobile telephone, and wherein the second electronic device identification data is a second mobile telephone number associated with the second electronic device.

12. A computer implemented method as claimed in claim 9 wherein the first electronic device is a mobile telephone, and wherein the first transaction data includes a first mobile telephone number associated with the first electronic device, the first mobile telephone number being receiving account identification information identifying the receiving account.

13. A computer-implemented method as claimed in claim 5, wherein the first data includes one or more of:
description data representing a description associated with the transfer of funds; and
quantum data representing an amount of the funds to be transferred.

14. A computer-implemented method as claimed in claim 5 wherein the sending account is linked to a credit card having a credit card number, wherein first transaction data includes a first part of the credit card number.

15. A computer-implemented method as claimed in claim 14 wherein the second transaction data includes a second part of the credit card number, the first part of the credit card number and second part of the credit card number together forming a complete credit card number.

16. A computer-implemented method as claimed in claim 15 wherein the second transaction data includes one or more of:
expiry data representing an expiry date of the credit card; and
verification data representing a card verification value or security code.

17. A system for facilitating the transfer of funds from a sending account to a receiving account using secure electronic communications, the system including:
a first message receiving component for receiving a first message from a first electronic device through a message interface, the first message including:
first transaction data representing partial sending account data representing partial sending account details, wherein the partial sending account details are insufficient to uniquely identify the sending account; and
second electronic device identification data uniquely identifying a second electronic device;
wherein the first and second electronic devices are capable of sending and receiving messages via a telecommunications network;
a first message processing component for processing the first message to generate a request message;
a request message transmitting component for transmitting the request message to the second electronic device identified by the second electronic device identification data;
a second message receiving component for receiving a second message from the second electronic device identified in the first message through a message interface, wherein the second message receiving component verifies the source of the second message using the second electronic device identification data and identification data embedded in the second message, wherein the second message contains data representing the remainder of the sending account details required to transfer the funds; and
a message combining component for combining information in the first message with information in the second message to generate combined transaction data for transmission to a transaction processor.

18. A system as claimed in claim 17, wherein the first message receiving component is configured to receive a first message including one or more of:
a first part of a credit card number, the credit card number having a first part and a remainder;
a transaction descriptor;
the amount to be transferred from the sending account to the receiving account; and
a unique identifier of the second electronic device.

19. A system as claimed in claim 18 wherein the request message transmitting component is configured to transmit a request message directed to the second electronic device using a unique identifier of the second electronic device, the request message including one or more of:
the transaction descriptor; and
the amount to be transferred from the sending account to the receiving account.

20. A system as claimed in claim 19 wherein the second message receiving component is configured to receive a second message from the second electronic device, the second message including one or more of:
the remainder of the credit card number;
the expiry date of the credit card bearing the credit card number;
a security code associated with the credit card bearing the credit card number.
